(19) United States
(12) Patent Application Publication
(10) Pub. No.: US 2008/0139122 A1
(43) Pub. Date: Jun. 12, 2008

(54) RDS Encoder For FM Transmitter

(75) Inventors: Raymon Hung, Vancouver (CA); Matthew Kendall, Vancouver (CA)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: ACCO Brands USA LLC, Lincolnshire, IL (US)

(21) Appl. No.: 11/839,169

(22) Filed: Aug. 15, 2007

Related U.S. Application Data
(60) Provisional application No. 60/869,277, filed on Dec. 8, 2006.

(51) Int. Cl. H04B 1/00

(52) U.S. Cl. 455/43

(57) ABSTRACT

The present invention provides a FM transmitter with Radio Data System (RDS) data transmission capability. In one embodiment, an RDS circuit is implemented in firmware. The firmware is configured in one or more stages to allow the RDS system to be integrated with a variety of FM transmission systems.

### CROSS-REFERENCES TO RELATED APPLICATIONS

This application is a non-provisional, and claims the benefit, of co-pending, commonly assigned, U.S. Provisional Application No. 60/869,277, filed Dec. 8, 2006, entitled “RDS ENCODER FOR FM TRANSMITTER,” the entirety of which is herein incorporated by reference for all purposes.

### BACKGROUND

The present invention relates generally to wireless communication, and more particularly to radio data system.

Radio Data System (RDS) is a world-wide radio standard used for sending small amounts of digital information using conventional FM radio broadcasts. The RDS system standardizes several types of information transmitted, including time and station identification. More recently, with regard to music, RDS has been used to convey digital information about a particular song such as song title, author, type of music, etc.

Generally, RDS transmission involves combining a RDS signal with a FM audio signal. The combined signal is used to modulate a FM transmitter which transmits an FM signal with the audio data and the RDS information to a FM receiver. The RDS receiver, or FM receiver capable of receiving an RDS signal, receives and separates the RDS data from the FM audio data to allow the two types of information to be processed separately.

In stereophonic FM transmission a pilot tone of 19 kHz is used to indicate stereophonic transmission to the FM receiver, and also is used to demodulate the stereophonic information. To avoid interference with the normal FM transmission, RDS uses a 57 kHz sub-carrier which is three times the pilot tone so as to operate outside the normal FM transmission bandwidth.

RDS transmission is conventionally done at radio stations where the FM is transmitted at a high power for long range FM transmission. Unfortunately, due to the hardware involved in implementing the RDS standard, the implementation of RDS has been proven to be complex and cost prohibitive for short range transmission systems.

There is therefore a need for a cost effective RDS system that is simple to integrate with lower power short range FM transmission systems.

### BRIEF SUMMARY

Embodiments of the present invention provide a FM transmitter with RDS transmission capability. In one embodiment, an RDS circuit is implemented in firmware. The firmware is configured in one or more stages to allow the RDS system to be integrated with a variety of FM transmission systems.

In one embodiment, the present invention provides a system that includes a processor and a computer readable storage medium coupled to the processor. The computer readable storage medium includes code for differentially encoding a radio data message from a radio data message source, and code for generating a bi-phase coded radio data signal from the differentially encoded radio data message. The system also includes a wireless transmitter. The wireless transmitter is adapted to transmit a wireless signal including the radio data message, wherein the wireless signal is derived from the bi-phase code radio-data signal.

In one embodiment, the present invention provides a wireless transmission system. The system includes a first logic circuit configured to digitally process a digital data signal received from a data source and a clock signal to generate a modulation signal. The data signal includes digital data pertaining to the content of a baseband signal. The system further includes a radio frequency transmitter circuit configured transmit a wireless signal carrying the radio signal and digital data in response the modulation signal and the baseband signal.

In one embodiment, the present invention provides a method of wirelessly transmitting within a radio data system a baseband signal and digital data pertaining to the baseband signal. The method includes processing digital data pertaining to the content of a baseband signal to form a first modulation signal, generating from the first modulation signal a plurality of harmonic signals, selecting one harmonic signal from the plurality of harmonic signals to generate a second modulation signal, summing the baseband signal with the second modulation signal to generate a third modulation signal, and modulating an output frequency of a wireless transmitter with the third modulation signal to generate a wireless signal transmitting the baseband signal and the digital data over a transmission medium.

These and other embodiments of the invention are described in further detail below.

### BRIEF DESCRIPTION OF THE DRAWINGS

FIG. 1 is a simplified block diagram of a FM transmission system including RDS data transmission in accordance with embodiments of the invention.

FIG. 2 is a schematic diagram of a FM transmitter with RDS in accordance with embodiments of the invention.

FIG. 3 is a schematic diagram of a 19 kHz pilot tone generation circuit in accordance with embodiments of the invention.

FIG. 4 is a flow-diagram of a method to generate a FM signal including RDS data in accordance with embodiments of the invention.

FIG. 5 is a high-level schematic diagram of a FM transmitter coupled to a RDS signal generation circuit in accordance with embodiments of the invention.

FIGS. 6A and 6B are high-level block diagrams of generating an RDS transmission signal in accordance with embodiments of the invention.

FIGS. 7A and 7B depict RDS data in accordance with embodiments of the invention.

FIG. 8 is a high-level block diagram illustrating generating a portion of a RDS data signal using a first firmware signal processing circuit in accordance with embodiments of the invention.

FIG. 9 is a waveform display of a portion of a RDS data signal using the first firmware signal processing circuit in accordance with embodiments of the invention.

FIGS. 10A-10C are waveform displays of a portion of a RDS data signal using the first firmware signal processing circuit in accordance with embodiments of the invention.

FIG. 11 is a high-level block diagram illustrating generating a portion of a RDS data signal using a second firmware signal processing circuit in accordance with embodiments of the invention.

FIGS. 12A and 12B are waveform displays of a portion of a RDS data signal using the second firmware signal processing circuit in accordance with embodiments of the invention.

FIGS. 13A-13D are waveform displays of a portion of a RDS data signal using the second firmware signal processing circuit in accordance with embodiments of the invention.

FIGS. 14A-14D are waveform displays of a portion of a RDS data signal using the second firmware signal processing circuit in accordance with embodiments of the invention.

FIG. 15 is a waveform displays of a portion of a RDS data signal using the second firmware signal processing circuit in accordance with embodiments of the invention.

FIG. 16A is a schematic of a mixing circuit and FIGS. 16B-16C are waveform displays of a portion of a RDS data signal mixed with a 57 kHz signal using a mixing circuit in accordance with embodiments of the invention.

FIG. 17A is a schematic of a filter circuit and FIGS. 17B-17C are waveform displays of a portion of a RDS data signal mixed with a 57 kHz signal after processing by the filter circuit in accordance with embodiments of the invention.

FIG. 18A is a high-level block diagram illustrating generating a portion of a RDS data signal using a third firmware signal processing circuit and FIG. 18B is a waveform display of a portion of a RDS data signal using the third firmware signal processing circuit in accordance with embodiments of the invention.

FIG. 19 is a waveform displays of a FIR filter response in accordance with embodiments of the invention.

FIGS. 20A and 20B are waveform displays of a FIR filter response in accordance with embodiments of the invention.

### DETAILED DESCRIPTION OF EXEMPLARY EMBODIMENTS

The present invention provides a FM transmitter with Radio Data System (RDS) data transmission capability. The information transmitted using the RDS system includes information about the content of the signal transmitted from the transmitter to the receiver, such as audio content, artist, radio station, and the like, as described herein. In one embodiment, an RDS circuit is implemented using firmware (e.g., software code) and hardware in combination. The firmware may be configured in one or more stages to allow the RDS system to be integrated with a variety of FM transmission systems capable of transmitting a signal to a receiver over a transmission medium such as air, conductors, optical paths, and the like.

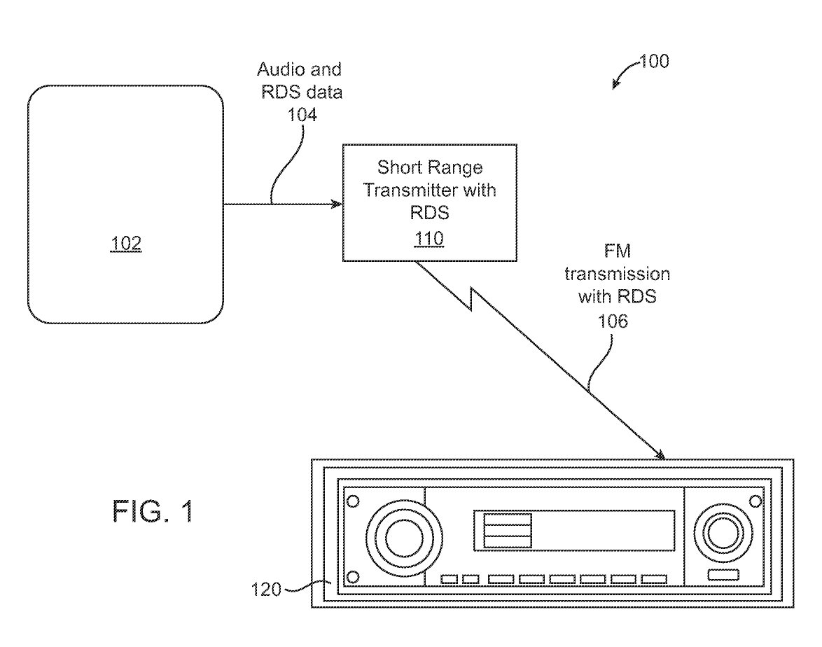

FIG. 1 is a simplified block diagram of a FM transmitter system 100 that is configured to transmit RDS data. In one embodiment, system 100 receives RDS data from a source 102 along with audio data and transmits a FM signal with RDS and audio data to a receiver 120. For example, system 100 may include any suitable audio source 102 capable of transmitting RDS, such as a MP3 player with RDS capability coupled to transmit data over communication channel 104 to FM transmitter 110. Communication channel 104 may be any suitable communication link such as hardwire links, optical links, satellite or other wireless communications links, wave propagation links, or any other suitable mechanisms for communication of information between the audio source and the FM transmitter 110. The FM transmitter 110 may be any suitable transmitter capable of transmitting audio and the RDS data to a receiver 120, such as an automobile radio, portable radio, and the like.

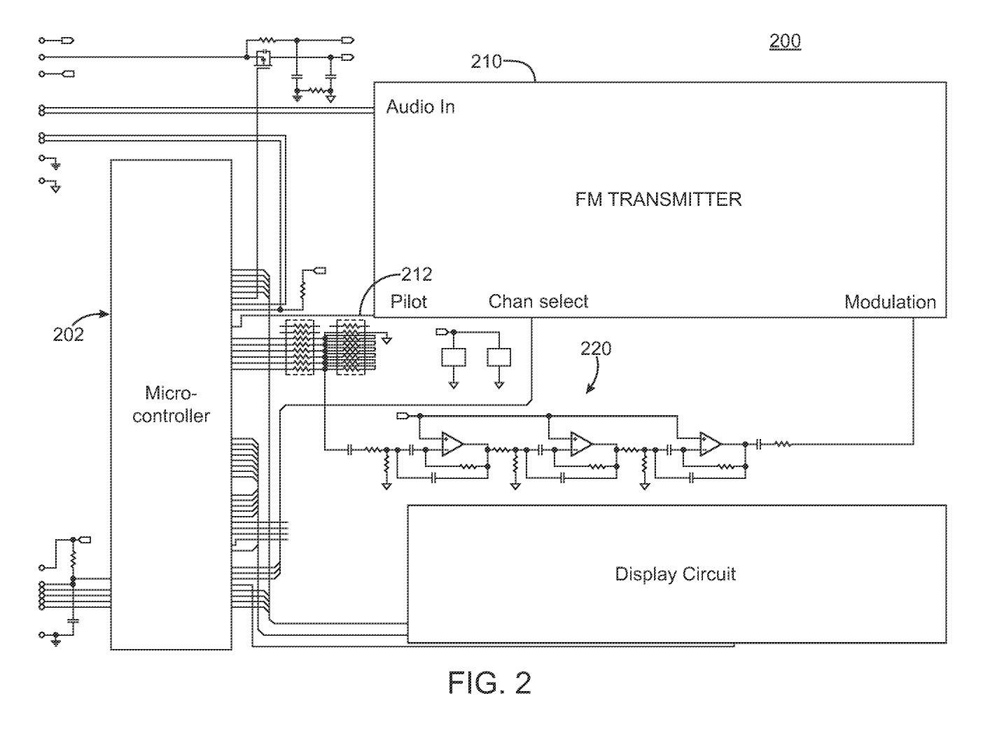

FIG. 2 is a schematic diagram of integrated circuit 200 which includes a FM transmitter with RDS data generation and transmission capability. The FM transmitter includes a RDS circuit 202 implemented in firmware, a FM transmitter 210, and an RDS filtering circuit 220. The FM transmitter 210 may be any suitable transmitter capable of receiving and transmitting an FM signal including a RDS signal to a receiver such as receiver 120. In one embodiment, the integrated circuit 200 is formed into a single integrated circuit, for example, formed onto a single integrated circuit or die.

In one embodiment, the RDS circuit 202 receives audio signals (i.e., baseband signals) and RDS signals from (i.e., digital data signals), for example, from source 102. For example, audio signals may be received on “L” and “R” pins of the FM transmitter 210, and the RDS signal may be received from source 102 as a digital word input to microcontroller 202. In other embodiment, the audio signals and the RDS signals may be combined into a multiplexed signal for later de-multiplexing. As describer further below, in one embodiment, during operation, the microcontroller 202 is configured to generate a modulation signal in response to a 19 kHz signal, and the RDS signal. The modulation signal is then combined with the audio signal to modulate the output frequency of the FM transmitter in order to transmit the RDS information and audio content to receiver 120.

Generation of the 19 kHz Clock

In one embodiment, circuit 200 generates a 19 kHz pilot tone to act as the master clock for the generation of the RDS signal, as per the RDS standard “Radio Data System for VHF/FM broadcasting” herein incorporated by reference for all purposes. As described herein, the 19 kHz pilot tone may be generated on-board the circuit 200 and/or may be provided by an external signal, for example, a signal generator.

In other embodiments, where the 19 kHz clock is not directly available on the FM transmitter 210, the 19 kHz clock may be extractable from a composite multiplex signal output if available from the FM transmitter 210, for example pin 212 of the FM transmitter 210 may be configured to output the composite multiplex signal. This composite multiplex signal contains base-band L+R audio, the 19 kHz pilot tone, and the L-R audio around 38 kHz. In some FM transmitters 210, due to multiplex mixing, the predominant feature of this waveform may be the 38 kHz switching frequency.

In embodiments of the present invention, the 19 kHz pilot tone may be extracted from the composite multiplex signal using a variety of suitable signal extraction techniques. For example, in one embodiment a narrowband filter centered on 19 kHz may be used to extract the pilot tone. However, there are some considerations with this approach. First, in one embodiment, the filter is narrow in bandwidth and centered on the pilot tone. Secondly, the audio signal is suitably band-limited to avoid encroaching on the 19 kHz tone. A phase lock loop (PLL) with low loop bandwidth to the recovered signal may be used to reduce jitter resulting from audio signal encroachment, and other signal processing issues.

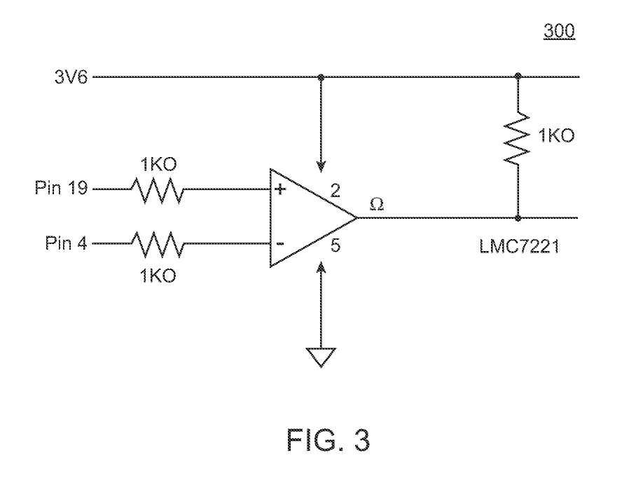

In one embodiment, FM transmitter 210 may be configured to produce the 19 kHz tone. For example, pin 212 may be configured to provide the 19 kHz Pilot tone. For FM transmitters 210 configured to supply the pilot tone, a 19 kHz digital clock signal may be further processed using a comparator 300 as illustrated in FIG. 3.

In one embodiment, the RDS signal requires a 57 kHz carrier frequency. In order to implement the 57 kHz RDS carrier, higher rate multiples of 19 kHz digital clock may be required. In particular, a three-times rate clock of the 19 kHz subcarrier may be configured to generate the 57 kHz. To generate required multiples of the 19 kHz frequency, in an embodiment, the 19 kHz is formed into a square wave, or approximation thereof, and the third harmonic is selected. For example, a 57 kHz clock may be generated by processing a 19 kHz squarewave with a band-pass filter centered on 57 kHz to extract the third harmonic, followed by squaring the result up to produce a digital signal. In one embodiment, the bandpass filter includes an op-amp and a comparator. A multistage filter is contemplated having two op-amps and configured with a relatively high Q to reduce jitter.

Generation of RDS Signal

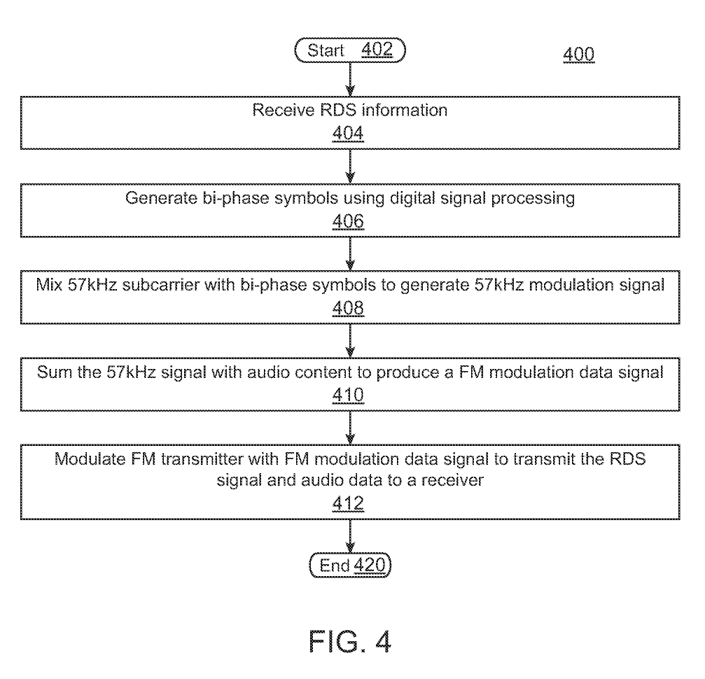

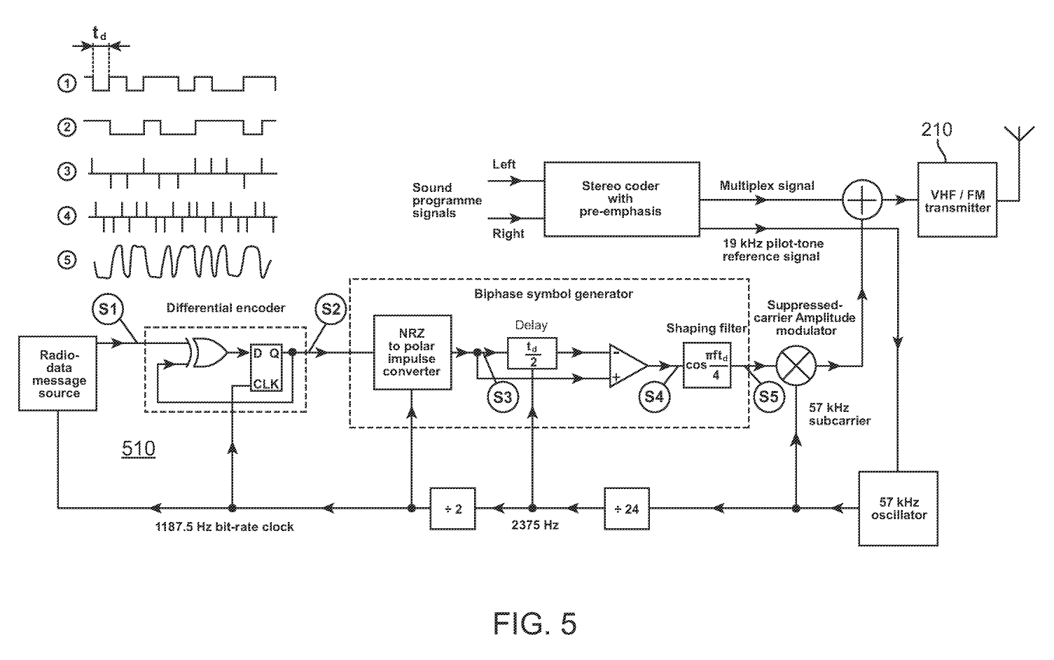

FIG. 4 is a flow-diagram of a method 400 to generate a FM signal including RDS data using for example a combination of hardware and firmware as disclosed herein. For example, RDS may be generated using a combination of firmware and hardware to generate some or all of the portions of an RDS signal as illustrated in FIG. 5, described further herein.

Method 400 may be entered into at step 402 by a user using system 100 to wirelessly transmit RDS data from a source 102 to a receiver 120. In one embodiment, with regards to the various firmware configurations as described below, at step 404, RDS information is obtained form the source 102. At step, 406 bi-phase symbols are generated from the RDS information. A 57 kHz sub carrier is generated that includes the bi-phase symbols at step 408. The 57 kHz sub carrier is summed with the audio data to produce the modulation signal used to modulate the FM transmitter output at step 410. At step 412, FM transmitter 210 generates a FM signal with the RDS data which is transmitted to a receiver 120. Method 400 ends at step 420.

For generating an RDS signal, there are at least two embodiments. For example, firmware may be written on a FM system microcontroller, for example a MSP430 microcontroller, or firmware could be written for a separate microcontroller.

Therefore, in one embodiment, for the purpose of demonstrating one embodiment of the present invention, Applicants provided firmware on a separate microcontroller, however, the present invention is not so limited. In one embodiment to reduce costs, the additional functionality may be implemented on the FM system microcontroller. For a more modular RDS add-on which might find application in several products, or to avoid major changes to the existing printed circuit boards, the additional functionality may be implemented in an additional microcontroller. The test firmware may be written is written in C or any suitable software programming language.

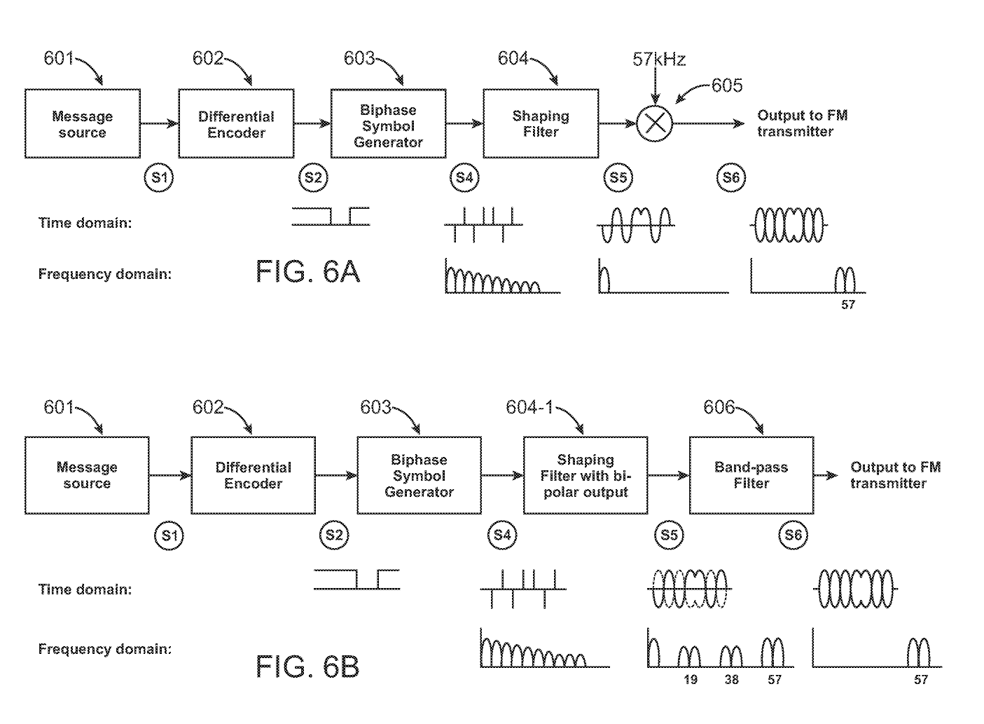

FIG. 5 is a high-level of a schematic diagram of a FM transmitter 210 coupled to a RDS signal generation circuit 510. FIGS. 6A and 6B are block diagrams illustrating various stages of generating an RDS data signal for input to the FM transmitter 210.

In one embodiment, FIG. 5 illustrates a block diagram of an RDS transmission system whereby a RDS modulation signal is generated and used to modulate the FM transmitter 210 to transmit RDS data to a receiver in accordance to the RDS standard. The RDS signal to be added to the transmitter modulation signal consists of a 57 kHz subcarrier amplitude-modulated with a 1.1875 kbps data stream which has been differentially encoded, and passed through a biphase symbol generator consisting of a biphase impulse generator and shaping filter stage. Signals S1 through S6 are numbered to illustrate signal processing at different signal processing stages. As illustrated, below the signal numbers, signals are represented in diagrams illustrating characteristic features of the signals in the time domain (amplitude versus time) and the frequency domain (amplitude versus frequency).

The data message source may originate in firmware, having been generated from the song information (e.g., data about the content of the baseband signal) extracted from the source 102 (e.g., iPod, MP3 player, etc.). Similarly, the 57 kHz subcarrier may ultimately exist as an analog signal, to be added to the transmit modulation signal.

In one embodiment, the RDS signal generation and addition to the FM carrier may be implemented in at least three embodiments using combination of firmware and analog hardware. For example, three configurations as described herein may include:
Generate waveform S4 in firmware and implement the shaping filter and the 57 kHz mix in hardware;
Generate waveform S5 in firmware and implement the 57 kHz mix in hardware;
Generate waveform S6 directly in firmware.

In embodiments of the present invention, message source stage 601 generates a data stream comprising successive binary digits (bits) of successive words of successive “blocks” of successive “groups” of a message properly formatted according to the RDS standard. The message carries the intended information. The result is signal S1 which is the input to the RDS encoder proper. Illustratively, the data rate may be configured to 1187.5 bits-per-second (bps). Embodiments of stage 601 may be provided either in logic hardware or in software.

Differential encoder stage 602 combines signal S1 with the current state of signal S2 in an exclusive-or operation to produce the next state of signal S2. In this example, the data rate is still 1187.5 bits-per-second. Embodiments of stage 602 may be provided either in logic hardware or in software.

Bi-phase symbol generator stage 603 may be configured to generate bi-phase impulses pairs from signal S2; such that a logic one gives a positive impulse followed by a negative one, and logic 0 gives the opposite result. The impulse rate in this illustration is 2375 Hz. In the frequency domain the spectrum has nulls at DC and 2375 Hz, and repeats at 2375 Hz intervals. Embodiments of stage 603 may be provided either in logic hardware or in software.

Shaping filter 604 stage is configured to shape the impulses from stage 603. In one embodiment, to shape the spectrum between DC and 2375 Hz to help eliminate the energy above 2375 Hz, the filter stage 604 has a raised-cosine frequency response. Embodiments of stage 604 may be provided either in logic hardware or in firmware. Filter stage 604 may be implemented in hardware given a suitable number of filter stages to obtain an adequate Q.

Mixer stage 605 multiplies (in the time domain) the signal S5 with a 57 kHz sub-carrier, generating signal S6 which is to be added to the audio stereo multiplex signal before frequency modulation of the radio carrier of the FM transmitter. Embodiments of stage 604 may be provided either in logic hardware or in firmware. Implementation of this stage in hardware is available with the availability of a 57 kHz clock source, and the like. Implementation of this stage in firmware is also available with the availability of a 2×57 kHz clock, and the like.

Generating Waveforms S1 and S2

For illustrative purposes, Applicants performed almost all the measurements of the RDS waveforms described herein with a pseudo-random bit-stream (PS) standing in for the RDS data at waveform S2.

In one embodiment, the firmware was configured to generate type 0B groups containing blocks containing PI, TP, PTY, TA, M/S and DI data with sensible default values, and PS data containing an arbitrary string. The firmware generates a sequence of four such groups to fill the eight-character PS string, then repeats the sequence generation. Illustratively, this sequence approximates the functionality required in a final product, except that the sequence is a fixed PS string whereas the final product may transmit a changing PS string to implement scrolling.

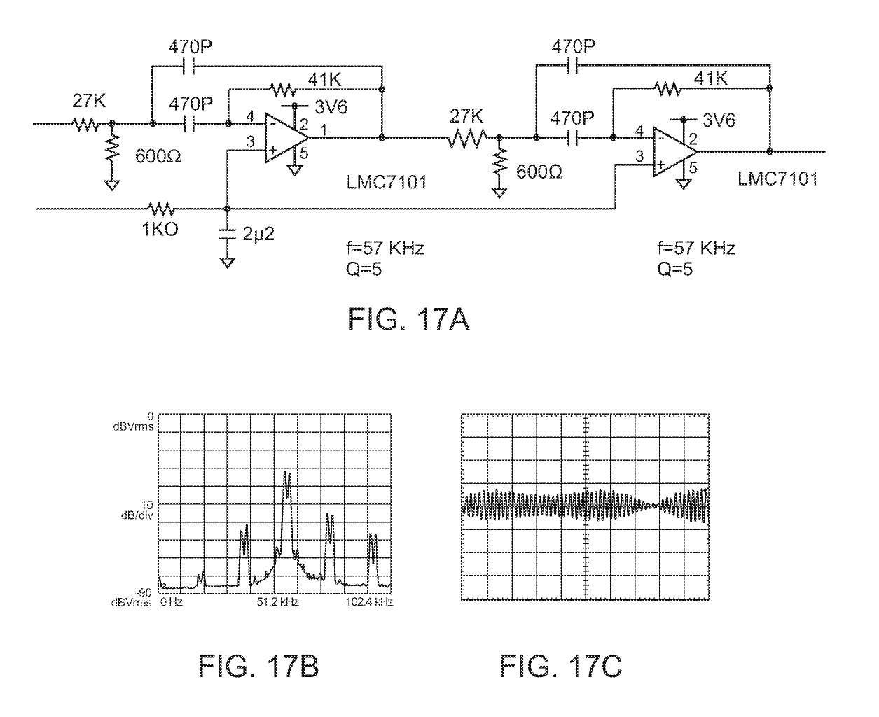

Applicants tests were indicative that the functions generating the RDS data are able to run in the background on the test microcontroller (5MIPS available) whilst the interrupt-driven generation of the RDS waveform runs concurrently. As described below, FIGS. 17B and 17C, illustrate the output of the 57 kHz band-pass filter processing such real RDS data.

In one embodiment, the RDS transmitter 110 may be configured without the mixer stage 605. For example, the shaping filter 604 may be implemented in software as a finite impulse response (FIR) filter 604-1 with the sampling frequency chosen as 19 kHz. This gives rise to images (e.g., harmonics) of the baseband signal centered around multiples of the sampling frequency. The bandpass filter 606 may be may be configured such that the third image of the output of the bandpass filter 606, centered around 57 kHz, is identical to the signal that would be produced by the mixer stage 605.

In another embodiment, generating the output of shaping filter 604 may be configured as a series of bi-polar impulses. With a conventional sample-and-hold output the frequency response exhibits a sin(x)/x response, emphasizing the baseband signal and reducing the other images. However, with such bi-polar pulse output the baseband is reduced and the images are emphasized. In embodiments of the present invention the time between positive and negative pulses is chosen as approximately 8.7 μs (one half the period of 57 kHz) to emphasize the image centered on 57 kHz.

In an embodiment, to reduce unwanted components in signal S5 at baseband, 19 kHz, 38 kHz, 76 kHz and higher to an acceptable level, the band-pass filter stage 605 is configured with a response on 57 kHz, which provides the desired 57 kHz signal S6.

Embodiments of the present invention may be configured to reduce the complexity of the implementation of shaping filter 604 by not requiring N multiplications and additions per output sample (where N is the filter length). For example, noting that although the filter is run at a sampling rate of 19 kHz, the input notionally consists of impulses at a rate of only 2375 Hz, with all samples between impulses being zero. Thus, in one embodiment, the shaping filter 604 may be implemented as a look-up table requiring only N×2375/19000=N/8 additions per sample. The effect of the bi-phase symbol generator 603 may be pre-computed and combined into the look-up table of the implementation of shaping filter 604, reducing the input rate of the filter from 2375 Hz to 1187.5 Hz, reducing the computational expense of the filter by a further factor of 2.

Song Display

This following describes one embodiment of the present invention related to communicating with the source 102 and extracting the audio data. Examples herein describe for example, sources 102 such as an iPOD™ from Apple computer, however, those skilled in the art will appreciate that other suitable sources my be used.

The source 102 communicates with simple peripherals over an RS232-like serial interface. Baud rates of 9600, 19200, 38400 and 57600 are supported, depending on the capability of the source 102. Where the source 102 provides 3.3V logic level signals rather than true RS232, interfacing to a microcontroller on the FM transmitter may not require level-shifting interface components.

In one embodiment, where the processor 202 does not provide a Universal Asynchronous Receiver/Transmitter (UART), the serial communications may be “bit-banged” in the firmware, i.e., implemented using general purpose I/O signals.

For example, in order to bit-bang the serial data, in one embodiment, the source 102 is polled for song information, spend ten seconds or so transmitting RDS to scroll this across the radio display, then suspend RDS transmission briefly whilst the source 102 is polled again for updated information. Applicants submit that preliminary experiments indicate that RDS receivers 120 sync quickly to the data stream, so interrupting it momentarily should not be a problem.

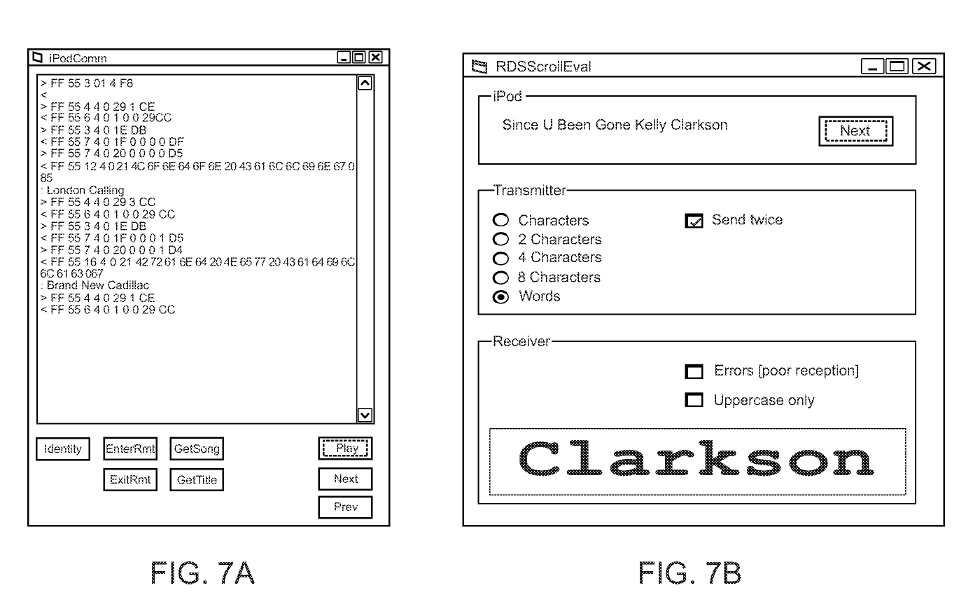

As illustrated in FIG. 7A, in one embodiment, the interface protocol of the source 102 may be configured to support several different types of messages, aimed at different types of peripheral devices (e.g., receivers 120). These different message types may be referred to as Lingos. Generally, receivers 120 support general Lingo, and each receiver 120 usually supports one other Lingo. For example, one Lingo necessary to extract song information is type 4, Extended Lingo. Extended Lingo is intended to support sophisticated remote control devices.

In one embodiment, Applicants process the RDS data to scroll data across the receiver display using the eight-character PS name as illustrated in FIG. 7B. For example, Scrolling strategies may include scrolling by single characters, in 2, 4 or 8 character chunks, and scrolling by whole words.

Generating Waveform S4 in Firmware

In one embodiment, firmware is used to generate waveform S4 at an effective sample rate, for example, of 2.4 ksps. The firmware may be configured to generate S4 such that unwanted side-lobes are removed to minimize audible interference in the L-R channel, and minimize the mixer imbalance to minimize audible interference in the L+R channel.

In one test embodiment, Applicants provided test firmware to generate waveform S4. At this point a pseudo-random sequence was used as the input to the biphase symbol generator.

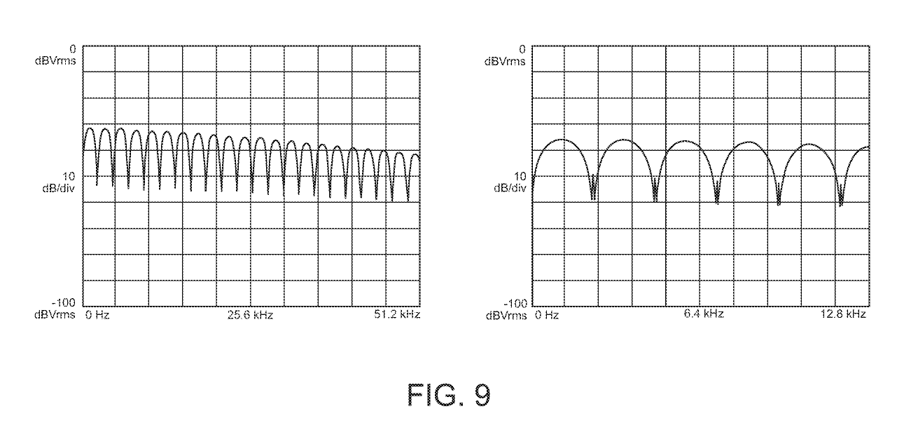

Waveform S4 was produced in an embodiment requiring a three-level signal by resistively combining two digital outputs. The spectrum has nulls at DC and 2.4 kHz, and repeats essentially flat. The three-level signal falls off with frequency (to a null above the plot limit) due to the finite pulse width, finite rise-time, and small parasitic RC filter. FIG. 9 shows the resulting waveform S4 in the frequency and time domains.

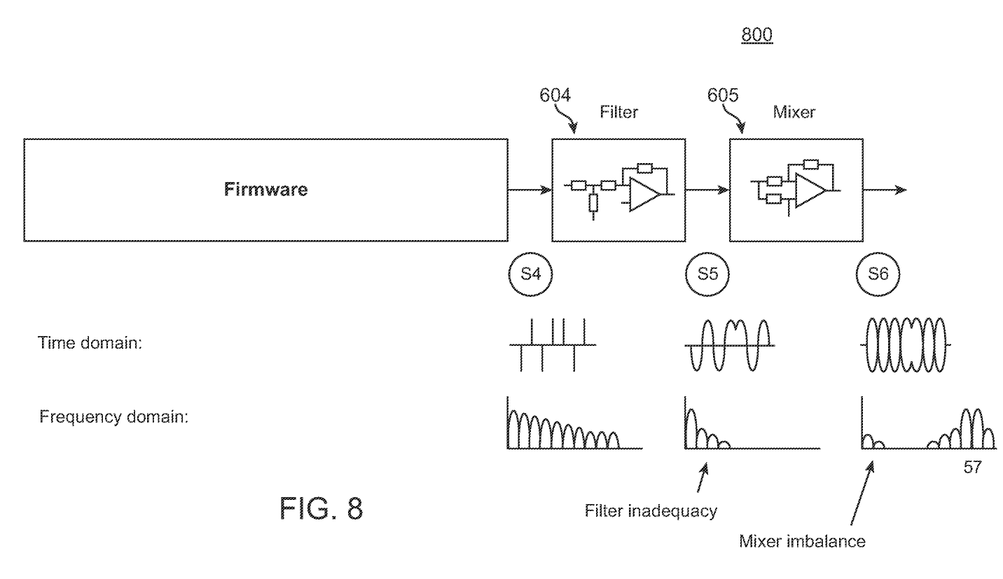

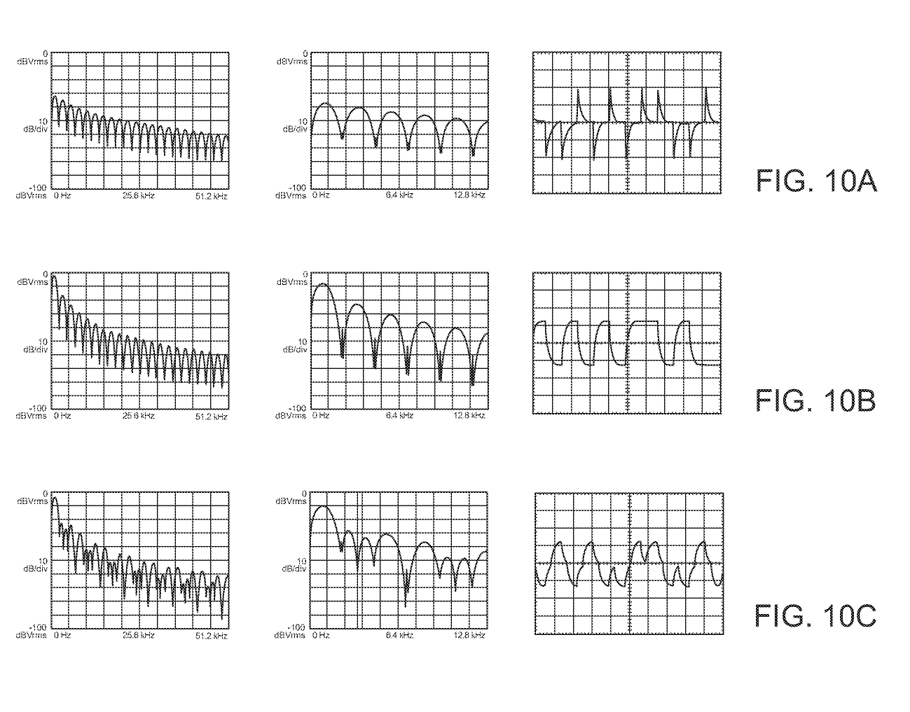

In one embodiment, the shaping filter 604 is configured to shape the energy below the 2.4 kHz null, and remove most if not all of the signal energy above 2.4 kHz to prevent such energy to ultimately being mixed into audible bands. FIGS. 10A-C show resulting waveform S5 in the frequency and time domains generated using the firmware and hardware configuration illustrated in FIG. 8.

In this illustration, the waveform is shown filtered with an RC filter (1 kw 100 nF) at 1.67 kHz. This is a first-order approximation of the shaping filter 604. The out-of-band signal peak is −6 dBc as illustrated in FIG. 10A. In one embodiment, a sample and hold may be introduced before the RC filter, with a full-pulse width hold time to provide encoding, such as Manchester encoding. The out-of-band signal peak is −22 dBc as illustrated in FIG. 10B. In an embodiment, to reduce an unwanted sidelobe, the sample and hold time may be adjusted, for example, to 280 us, to generate a null at 3.6 kHz. The out-of-band signal peak is −20 dBcs illustrated in FIG. 10C.

As illustrated, where the firmware generates waveform S4, approximations to the analog shaping filter 604 may provided. In this embodiment, the shaping filter 604 may be configured very steep around 2.4 kHz in order to adequately suppress the unwanted sidelobes without affecting the selected signal. Applicants submit that preliminary calculations indicate that a forth-order filter may be used (i.e., two op-amps).

In one embodiment, the mixing does not have to be full four-quadrant multiplication. The 57 kHz subcarrier can be a squarewave with levels of +1 and −1, so the mixer can simply be an alternating inversion followed by a low-pass filter to remove the harmonics. For example, the low pass filter may be formed using an op-amp and analog switch.

Generating Waveform S5 in Firmware

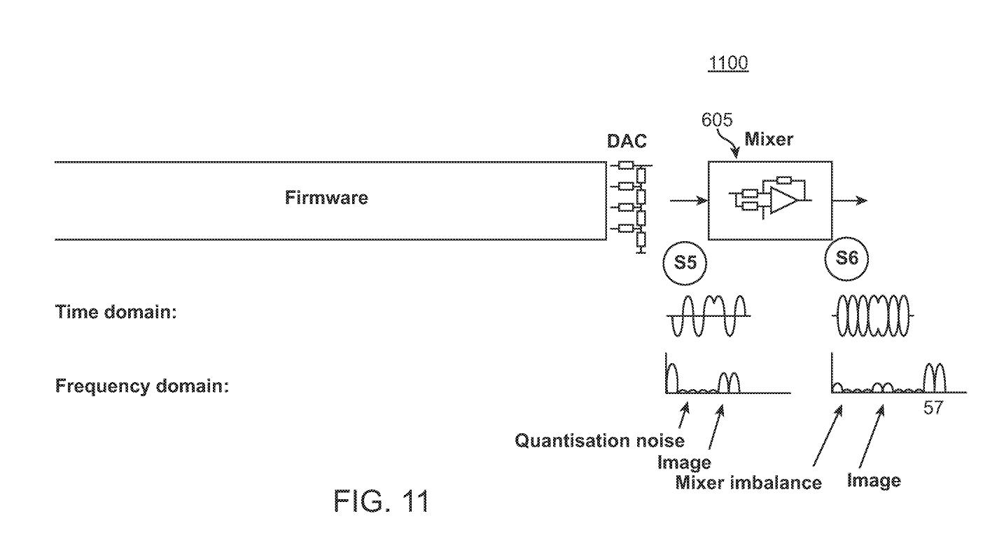

FIG. 11 is a high-level block diagram illustrating generating a portion of a RDS data signal using a second firmware signal processing circuit 1100. In one embodiment, waveform S5 may be generated in firmware when the microcontroller 202 is configured with a digital-to-analog converter (DAC). For example, such a DAC may be implemented using a simple R-2R ladder connected to a set of digital outputs.

As described above, the shaping filter 604 may be implemented in firmware using a FIR allowing waveform S5 to be generated and filtered at any suitable sample rate. In one embodiment, when higher sample rates are employed, such shaping filter 604 may be configured to filter any unwanted signals as higher sample rates extend the images further away in the frequency domain which simplifies post-DAC filtering. As such, the resolution of the DAC (number of bits) sets the quantization noise floor.

In one test configuration, Applicants provided test firmware to generate waveform

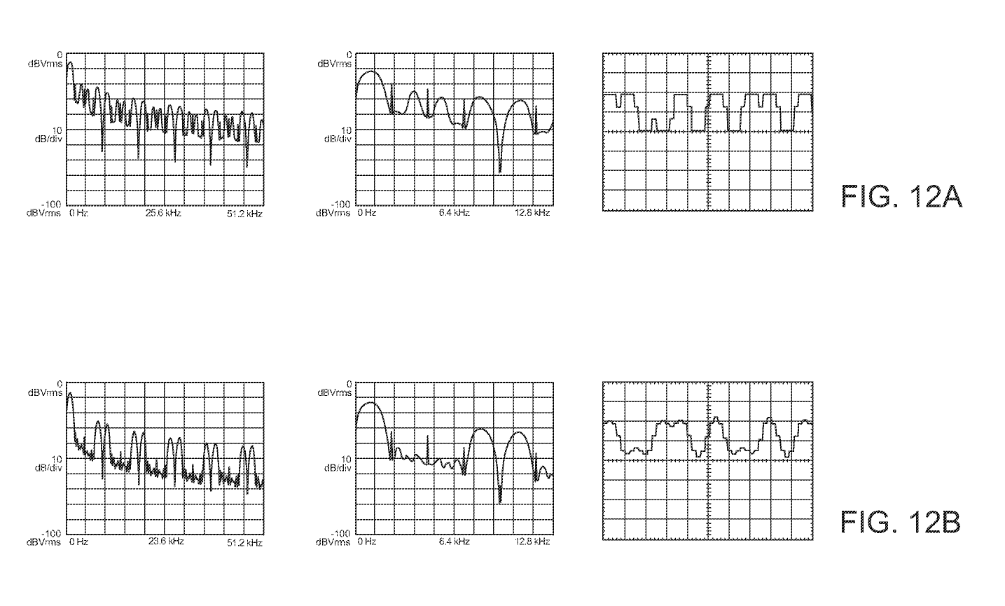

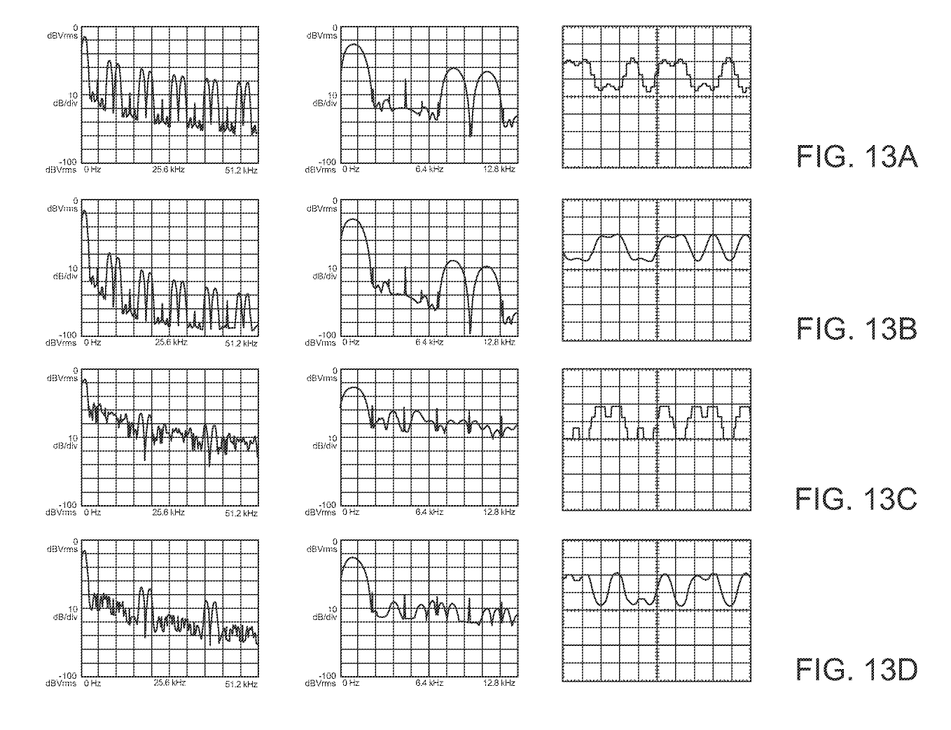

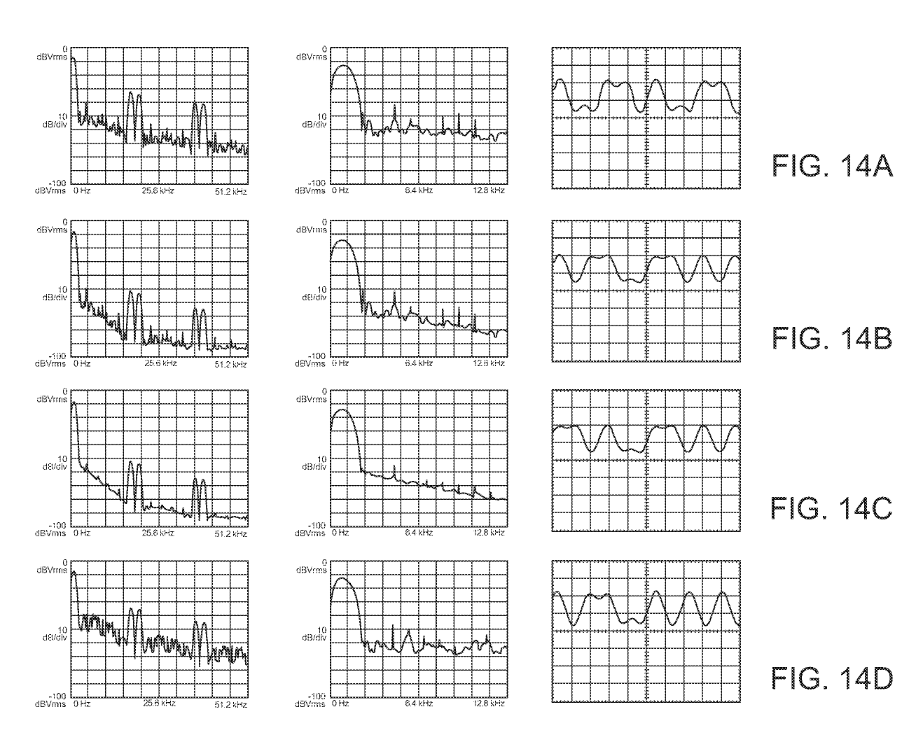

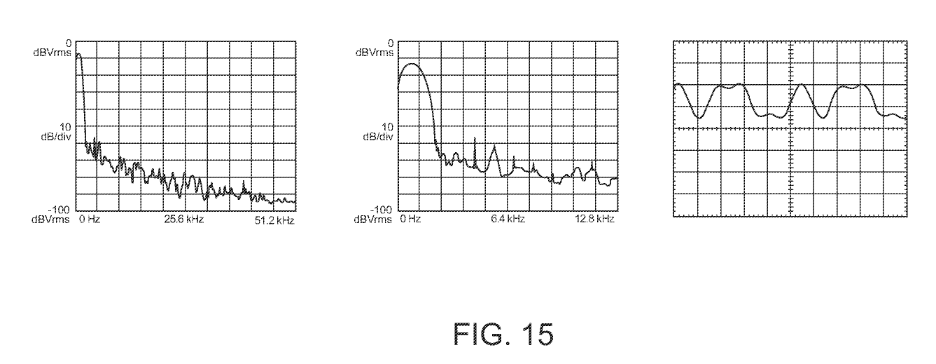

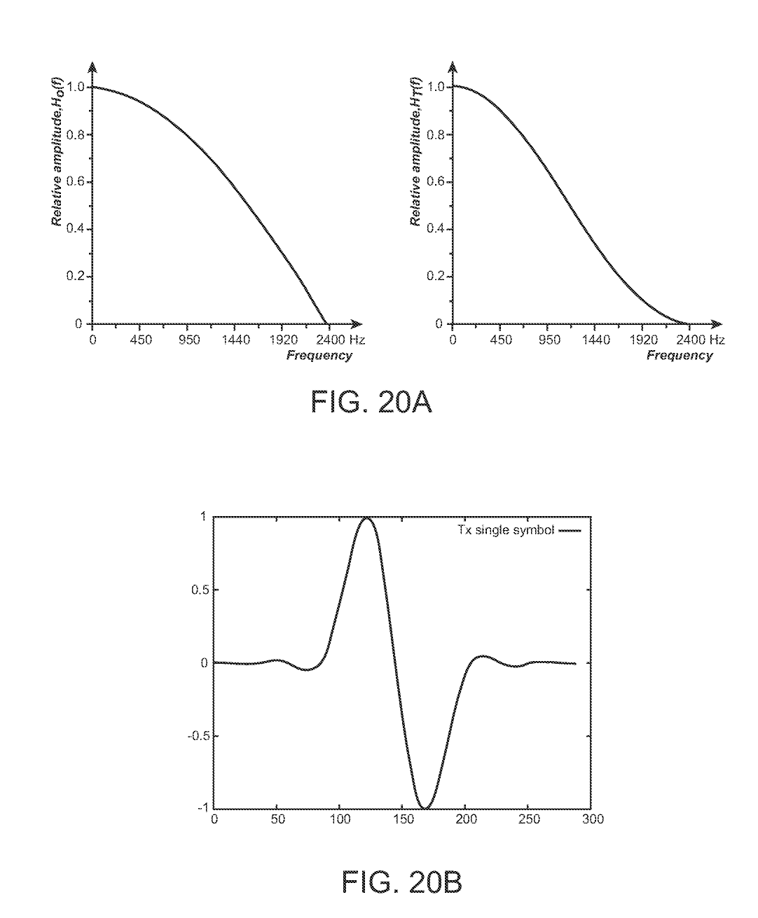

S5. A pseudo-random sequence was used as the input to the biphase symbol generator. Various combinations of sampling rate, DAC resolution and FIR length were investigated. The calculation of the FIR filter coefficients is shown in FIGS. 20A and 20B described below. FIGS. 12A-B, FIGS. 13A-D, FIGS. 14A-D, and FIG. 15 show the resulting waveform S5 in the frequency and time domains. For example, FIG. 14B illustrates a 19 k sample rate, 48-tap FIR (3 symbols), with a 6-bit DAC, FIG. 14C illustrates a 19 k sample rate, 48-tap FIR (3 symbols), with a 6-bit DAC, RC filter 1.67 kHz, FIG. 14D illustrates a 19 k sample rate, 48-tap FIR (3 symbols), with a 6-bit DAC, 0.5-bit dither, and RC filter 1.67 kHz, and FIG. 15 illustrates a 57 k sample rate, 144-tap FIR (3 symbols), a 6-bit DAC, and RC filter 1.67 kHz.

In one embodiment, 6 bits of DAC resolution may be required to produce an adequately low noise floor. To provide smoothing of the noise, a small amount of dither may be employed.

Where processing overhead of microcontroller is low, in one embodiment, a suitable sample rate may be employed to allow for adequate filtering while minimizing the amount of processing overhead. A lower 9.5 ksps rate the image may be too close to the desired signal to be effectively removed with a conventional RC filter. At the higher 57 ksps rate the firmware required about 3MIPS which may be close to the limit of some conventional microcontrollers. In an embodiment, a 19 ksps sample rate may be used to allow for signal filtering while minimizing the amount of processing overhead.

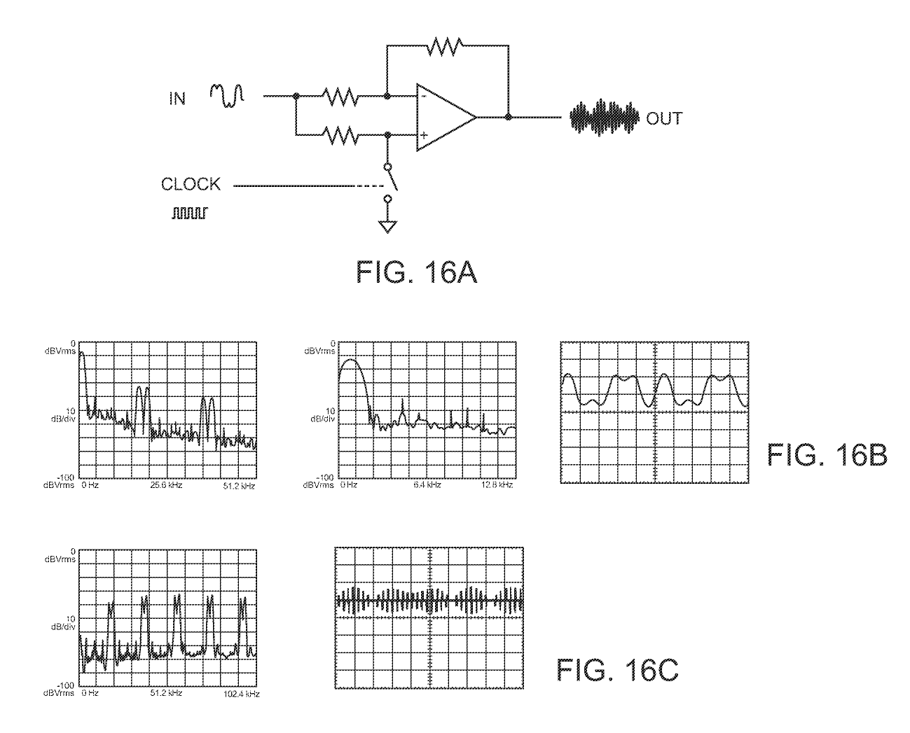

In embodiments of the present invention, waveform S5 is generated in firmware at a 19 ksps sample rate which is then mixed with 57 kHz in hardware. This configuration may utilize a DAC, a first-order RC post-DAC filter, and a double-sideband suppressed-carrier AM mix to 57 kHz. In other embodiments, a suitable post-mix band-pass filter may be used to remove harmonics and other undesired products. In one embodiment, the mix may be accomplished using a 57 kHz clock and an alternating-inversion type mixer, such as shown in FIG. 16A.

As discussed above, the generation of a 57 kHz clock may require a band-pass filter containing two op-amp stages and a comparator. The mixer likely requires an op-amp plus an analog switch, or something of similar complexity. An additional op-amp may also be required to buffer the mid-rail virtual earth. Applicants contemplate that such stages may be optional.

For Example, as illustrated in FIG. 16B, as described above the output of the FIR configured to operate at a 19 k sample rate, 48-tap FIR (3 symbols), using a 6-bit DAC, outputs several images at multiples of 19 kHz. The image centered on 57 kHz as illustrated may be used as the 57 kHz clock. As described above, the images are suppressed with respect to the base-band because the DAC output is processed with sample and hold which results in an overall sin(x)/x spectrum. Alternatively, the FIR output may be generated such that a series of pulses is generated to within a first approximation can make the images just as large as the base-band. Furthermore, if the FIR output is configured with a series of bi-phase pulses the base-band may be suppressed entirely and make the desired 57 kHz image dominant. For example, FIG. 16B shows the DAC output when the firmware is configured to generate bi-phase pulses of approximately 6 us (note changed frequency scale). Therefore, the image at 57 kHz centered in FIG. 16B is the desired 57 kHz clock signal generated without any requirement for a separate 57 kHz clock, or for a hardware mixer.

In order to remove unwanted images (i.e., signals), a band-pass filter may be used. For example, a band-pass filter may be configured to remove the unwanted images about the 57 kHz signal, primarily those around 38 kHz and 19 kHz. Because the RIDS signal is itself 31 dB down on the peak audio due to the +2 kHz peak deviation vs. ±75 kHz peak deviation, a further 30 dB of suppression may be generated by the band-pass filter to provided about 60 dB signal suppression.

In one embodiment, a further 30 dB of suppression may be achieved with a band-pass filter with a Q of 10, such as illustrated in FIG. 16C. Alternatively, two stages with a Q of 5 may be cascaded. The actual schematic implemented for test purposes is illustrated in FIG. 17A. FIGS. 17B and 17C shows the output of the filter in FIG. 17A. In one embodiment, the filtered signal may be added to the transmitted multiplex signal using resistively coupling.

Generating Waveform S6 in Firmware

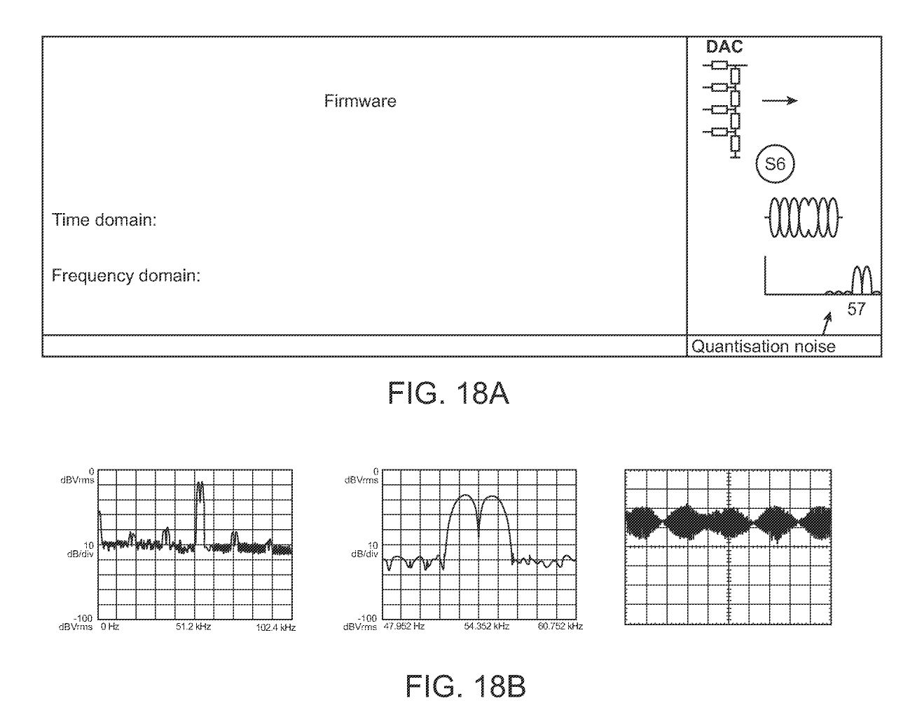

FIG. 18A is a high-level block diagram illustrating generating a portion of a RDS data signal using a third firmware signal processing circuit, and FIG. 18B is a waveform display of a portion of a RDS data signal using the third firmware signal processing circuit. In one embodiment, both the mixer and shaping filter may be implemented in firmware allowing waveform S6 to be generated directly in firmware. In one embodiment, waveform S6 may be generated at a sample rate of at least 114 ksps, although a lower rate can be used for the FIR.

Illustratively, Applicants provided firmware to generate waveform S6. A pseudo-random sequence was used as the input to the biphase symbol generator. FIG. 18B illustrates the resulting waveform S6 in the frequency and time domains having 57 k FIR sample rate, 114 k mixer output sample rate, 144-tap FIR (3 symbols), and using a 6-bit DAC, mix by (1,−1). Note the changed frequency and time scales compared with the plots described above. In this embodiment, it is noted that due to the firmware configuration, minimal band-pass filtering may be used at 57 kHz to produce the required signal.

Audio Filtering

In one embodiment, additional low-pass filtering may be added to the audio signal before it is coupled to the FM transmitter audio inputs. For example, one approach is to use two op-amps acting as differential amplifiers for the L and R input signals from the source. Alternatively, a low-pass response may be produced with the addition of passives, without requiring further op-amps.

An alternative approach would be to filter the multiplex signal to notch out the 57 kHz band, prior to adding the RDS signal to produce the modulation signal for the FM transmitter 210. This approach has the advantage of removing the 57 kHz harmonic of the pilot tone.

FIR Filter Coefficients

The calculation of the coefficients for the various FIR filters are illustrated. Referring to FIGS. 6A and 6B, each source bit at S2 gives rise to an odd impulse-pair at S4, such that a logic one gives a positive impulse followed by a negative one, and logic 0 gives the opposite. After passing through the shaping filter 604, the signal S5 is configured to modulate the 57 kHz subcarrier.

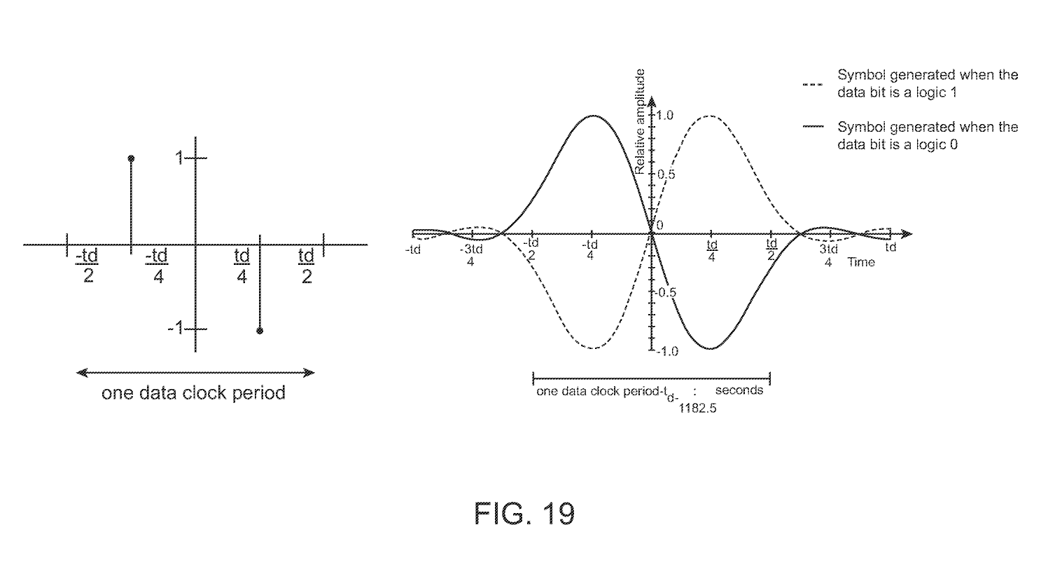

For illustration purposes, the shaping filter 604 is shown as non-causal, with influence extending both before and after the stimulus as illustrated in FIG. 19. A realizable implementation using a physical filter will have some delay. There is considerable ISI. The influence of the filtered impulse-pair extends more than half a bit period into the previous and next symbols. Thus, to calculate the signal at S5 for a particular bit period, the current bit and the previous and following bits must be accounted for.

The shaping filter is defined as:

$$H ( F ) = cos ( \frac{{π ft}_{d}}{4} ) for 0 \leq f \leq \frac{2}{{t}_{d}} , zero otherwise .$$

Since the same filter is to be used in the receiver, the overall end-to-end response is a full raised cosine as illustrated in the following equation and FIG. 20A.

$$( since {cos}^{2} θ ≡ \frac{1}{2} ( 1 - cos 2 θ ) )$$

The following calculations were performed by octave, but with minor changes the same file could be used, for example with Matlab or Scilab.

# To determine the signal at (5) we first start with the filter H.
# N is an arbitrary constant which sets the number of points to be
# calculated. We choose a value which will result in a convenient
# number of time-domain samples in the final result. There are N
# samples in the frequency domain between 0 and 2/td, and we pad
# with zeros for a total of N\hat{ }2 samples.
N=48;
n=[0:N−1];
H=[cos(n*pi/(2*N)) zeros(1,N\hat{ }2−N−1)];
# Now we calculate the time domain impulse response of the filter
# by taking the real part of the inverse fourier transform.
h=real(ifft(H));
# Calculate the transmit waveform as a positive impulse followed
# by negative impulse half a bit peroid later. Because the filter
# is causal the calculated impulse response h starts at the centre
# of the response, so we glue two copies back-to-back to see the
# full symmetrical waveform. As per the spec, we normalise the
# waveform so the maximum amplitude is unity.
pp=[h h zeros(1,N)];
np=[zeros(1,N) −h −h];
pnp=pp+np;
tx3=pnp(N\hat{ }2+N/2−3*N:N\hat{ }2+N/2+3*N);
tx3=tx3/max(tx3);
plot(tx3,“;Tx single symbol;”)

The required coefficients are now available in the variable “tx3,” which is illustrated in FIG. 20B.

Advantages of embodiments of the present invention include elimination of the mixer stage reduces cost by removing the need for a hardware mixer circuit, or by removing the need for sufficient processing power to implement a mixer in software (i.e., reducing the cost of the processor required). Elimination of the mixer stage removes the need for a 57 kHz or 2×57 kHz clock signal, phase locked to the 19 kHz stereo pilot tone, which may not readily be available. The requirement is only for a 19 kHz clock, which is present in a stereo FM transmitter by definition as the stereo pilot tone. Reduction of the complexity of the shaping filter reduces costs by reducing the processing power required for its implementation (i.e., reducing the cost of the processor required).

Any of the above described steps may be embodied as computer code on a computer readable medium. The computer readable medium may reside on one or more computational apparatuses and may use any suitable data storage technology.

The present invention can be implemented in the form of control logic in software or hardware or a combination of both. The control logic may be stored in an information storage medium as a plurality of instructions adapted to direct an information processing device to perform a set of steps disclosed in embodiment of the present invention. Based on the disclosure and teachings provided herein, a person of ordinary skill in the art will appreciate other ways and/or methods to implement the present invention.

The above description is illustrative but not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

A recitation of “a,” “an” or “the” is intended to mean “one or more” unless specifically indicated to the contrary.

All patents, patent applications, publications, and descriptions mentioned above are herein incorporated by reference in their entirety for all purposes. None is admitted to be prior art.

What is claimed is:

1. A system comprising:
a processor;
a computer readable storage medium coupled to the processor, wherein the computer readable storage medium comprises:
(i) code for differentially encoding a radio data message from a radio data message source; and
(ii) code for generating a bi-phase coded radio data signal from the differentially encoded radio data message; and
a wireless transmitter, wherein the wireless transmitter is adapted to transmit a wireless signal including the radio data message, wherein the wireless signal is derived from the bi-phase coded radio-data signal.

2. The system of claim 1, wherein the radio data message is generated using a pilot tone having a frequency of about 19 kHz.

3. The system of claim 1, wherein the code for generating the bi-phase coded radio data signal comprises code for generating bi-phase impulse pairs.

4. The system of claim 1, further comprising code to filter the bi-phase coded radio data signal to remove signals above 2,375 Hz.

5. The system of claim 1, further comprising code for multiplying a filtered version of the bi-phase coded radio data signal with a 57 kHz signal to generate a mixed signal which is added to an audio stereo multiplex signal to form a modulation signal, wherein the modulation signal is used to modulate the wireless transmitter.

6. The system of claim 1, further comprising code for generating a subcarrier with the bi-phase coded radio data signal.

7. The system of claim 6, wherein code for generating a subcarrier comprises code for forming a finite impulse response filter configured to generate the subcarrier in response to a predetermined input sampling frequency.

8. The system of claim 7, wherein the input sampling frequency comprises 19 kHz.

9. A wireless transmission system comprising:
a first logic circuit configured to digitally process a digital data signal received from a data source and a clock signal to generate a modulation signal, wherein the data signal comprises digital data pertaining to the content of a baseband signal; and
a radio frequency transmitter circuit configured to transmit a wireless signal carrying the radio signal and digital data in response the modulation signal and the baseband signal.

10. The system of claim 9, wherein the logic circuit comprises a microcontroller configured as a digital signal processor configured to generate the modulation signal in response to the digital data signal.

11. The system of claim 9, wherein the wireless signal is formed from the sum of a multiplex signal and the modulation signal.

12. The system of claim 11, wherein the multiplex signal comprises an audio signal.

13. The system of claim 9, wherein the first logic circuit comprises a second logic circuit configured to generate a bi-phase coded radio data signal portion of the modulation signal.

14. The system of claim 11, wherein the first logic circuit comprises a third logic circuit configured to process the bi-phase coded radio data signal to generate a sub-carrier portion of the modulation signal used to carry the digital data.

15. The system of claim 12, wherein the third logic circuit is configured as a finite impulse response filter used to select the sub-carrier portion of the modulation signal.

16. A method of wirelessly transmitting within a radio data system a baseband signal and digital data pertaining to the baseband signal, the method comprising:
processing digital data pertaining to the content of a baseband signal to form a first modulation signal;
generating from the first modulation signal a plurality of harmonic signals;
selecting one harmonic signal from the plurality of harmonic signals to generate a second modulation signal;
summing the baseband signal with the second modulation signal to generate a third modulation signal; and
modulating an output frequency of a wireless transmitter with the third modulation signal to generate a wireless signal transmitting the baseband signal and the digital data across a transmission medium.

17. The method of claim 16, wherein processing comprises digital signal processing performed by a processor configured to generate the first modulation signal from the digital data.

18. The method of claim 16, wherein the third modulation signal is formed without mixing signals together.

19. The method of claim 16, wherein the first modulation signal comprises bi-phase symbols.

20. The method of claim 16, wherein selecting comprises filtering the harmonic signals to generate the selected one harmonic signal.

21. The method of claim 19, wherein filtering comprises processing the first modulation signal using a finite impulse response filter.

22. A device configured to receive content comprising at least radio data system (RDS) data and wirelessly transmit the RDS data to a receiver, the portable device, comprising:
an input configured to receive the content from a portable source;
circuitry configured to convert the content into a wireless signal in response to a pilot tone signal having a frequency less than about 50 kHz; and
a wireless transmitter configured to transmit the wireless signal over a short range.

23. The device of claim 22, wherein the pilot tone signal comprises a signal having a frequency of approximately 19 kHz.
